(19) United States
(12) Patent Application Publication
(10) Pub. No.: US 2025/0386225 A1
(43) Pub. Date: Dec. 18, 2025

(54) Machine Learning Assisted Beam Selection

(71) Applicant: Apple Inc., Cupertino, CA (US)

(72) Inventors: Yushu Zhang, Beijing (CN); Haitong Sun, Cupertino, CA (US); Weidong Yang, San Diego, CA (US); Huaning Niu, San Jose, CA (US); Hong He, Cupertino, CA (US); Oghenekome Oteri, San Diego, CA (US); Wei Zeng, San Diego, CA (US); Dawei Zhang, Saratoga, CA (US)

(21) Appl. No.: 18/834,793

(22) PCT Filed: Feb. 9, 2022
(86) PCT No.: PCT/CN2022/075634

§ 371 Date: Feb. 12, 2025

(51) Int. Cl. H04W 24/10; H04B 7/06; H04L 5/00; H04W 16/14

(52) U.S. Cl. CPC H04W 24/10; H04B 7/0639; H04B 7/06952; H04L 5/0094; H04W 16/14

(57) ABSTRACT

This disclosure relates to techniques for performing beam selection using machine learning assistance in a wireless communication system. A wireless device and a cellular base station may establish a wireless link. An artificial intelligence model to use for beam selection may be determined. Channel impulse response information for a cell in a first frequency range may be determined. A downlink beam for a cell in a second frequency range may be selected based at least in part on the artificial intelligence model and the channel impulse response information for the cell in the first frequency range.

### PRIORITY INFORMATION

This application is a national phase entry of PCT Application No. PCT/CN2022/075634, entitled “Machine Learning Assisted Beam Selection,” filed Feb. 9, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for performing beam selection using machine learning assistance in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™ etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing beam selection using machine learning assistance in a wireless communication system.

The techniques may make use of channel information for a cell in one frequency range to perform beam selection for a cell in a different frequency range. Various aspects of the techniques can be performed by either of a wireless device or a cellular base station.

For example, it may be possible to both train an artificial intelligence model for use in such beam selection and perform inference using the artificial intelligence model on the cellular base station side, or to both train such an artificial intelligence model perform inference using the artificial intelligence model on the wireless device side, or it may be possible to train such an artificial intelligence model on the base station side and perform inference on the wireless device side, or it may be possible to train such an artificial intelligence model on the wireless device side and perform inference on the base station side.

The channel information used for the inference may be obtained by either the wireless device or the cellular base station, according to various embodiments. For example, the cellular base station may be able to configure the wireless device to receive downlink reference signals, obtain the channel information based on the downlink reference signals, and either use directly or report back to the cellular base station on the channel information obtained, or may be able to configure the wireless device to transmit uplink reference signals, receive those uplink reference signals, and obtain the channel information based on the uplink reference signals.

The techniques may enable the beam selection to be performed more efficiently than if direct downlink beam measurement were used, which could require more and/or higher powered reference signal transmission and measurement than the techniques described herein, at least according to some embodiments.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for performing beam selection using machine learning assistance in a wireless communication system, according to some embodiments; and

FIGS. 6-11 illustrate exemplary aspects of various possible approaches to performing beam selection using machine learning assistance, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
CORESET: Control Resource Set
RNTI: Radio Network Temporary Identifier
AI: Artificial Intelligence
NN: Neural Network
CIR: Channel Impulse Response
CSI: Channel State Information
CSI-RS: Channel State Information Reference Signal
SSB: Synchronization Signal Block
CQI: Channel Quality Indicator
PMI: Precoding Matrix Indicator
RI: Rank Indicator.
FR: Frequency Range

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

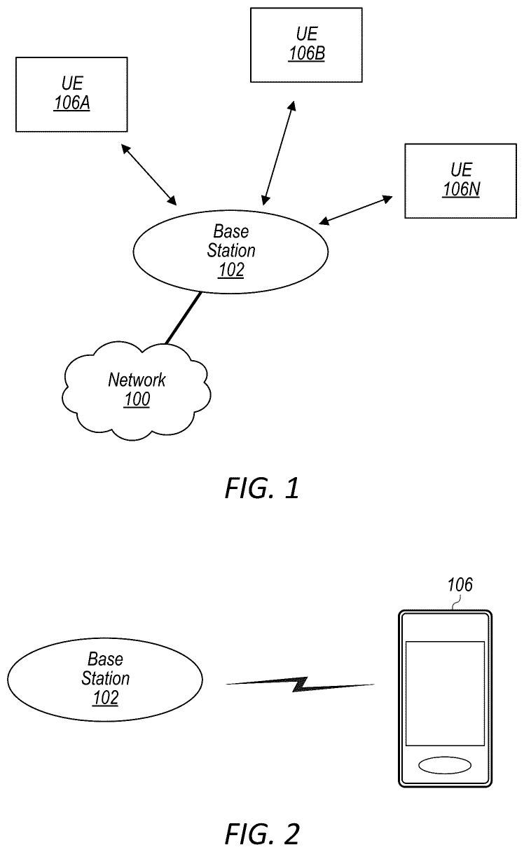

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for beam selection using machine learning assistance in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

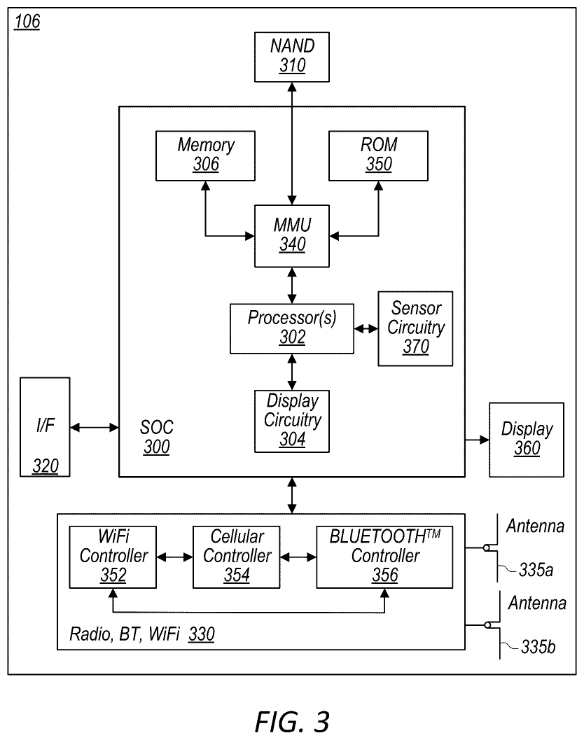

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for beam selection using machine learning assistance in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for beam selection using machine learning assistance in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

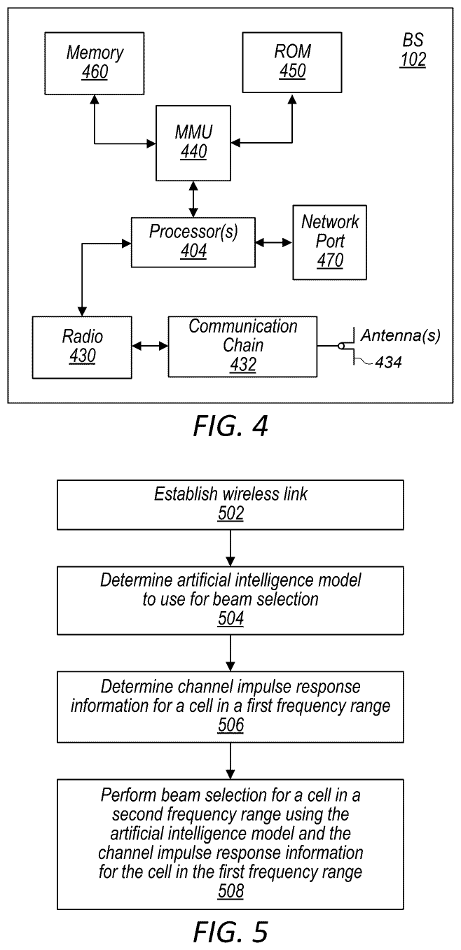

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### REFERENCE SIGNALS

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Nₜ represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

FIG. 5—Beam Selection with Machine Learning Assistance

Increasing interest is developing in use of artificial intelligence and machine learning type algorithms and tools. It may be possible to utilize such tools in any of a variety of possible areas of cellular communication. One such area may include beam selection, for example for cells that operate in frequency ranges in which beamforming is commonly used to improve link budget and/or other wireless communication system characteristics.

In some instances, it may be possible to use channel information from a cell in one frequency range to perform artificial intelligence based beam selection for a cell in another frequency range, and that such a method for beam selection may be more power and resource efficient than performing beam selection for that cell using existing techniques. This may be the case when performing beam selection for a cell directly would require transmission of multiple reference signals over a period of time, using different beams, and measurement of which of those beams has the best performance, and when inferring the beam that would have the best performance using channel information from a cell operating in a different frequency range using an artificial intelligence model can be performed based on a single (or otherwise fewer) reference signal transmission, at least in some instances. For example, if fewer reference signal transmissions are needed, there may be less network resource overhead needed, and if fewer reference signal measurements are needed, there may be less power consumption required by the (e.g., potentially battery constrained) wireless device, to perform the beam selection, at least according to some embodiments.

In order to support use of such techniques, it may be important to provide a framework according to which a wireless device and a cellular network can exchange information to determine whether such techniques are mutually supported and potentially to negotiate or agree upon the characteristics and parameters according to which artificial intelligence/machine learning based beam selection is performed, and/or to exchange information for supporting the operation of the artificial intelligence use in performing cellular communication, as well as to provide techniques for the use of artificial intelligence in performing cellular communication.

Thus, it may be beneficial to specify techniques for supporting machine learning based beam selection. To illustrate one such set of possible techniques, FIG. 5 is a flowchart diagram illustrating a method for performing beam selection using machine learning assistance in a wireless communication system, at least according to some embodiments.

Aspects of the method of FIG. 5 may be implemented by a wireless device and/or a cellular base station, such as a UE 106 and/or a BS 102 illustrated in and described with respect to various of the Figures herein, or more generally in conjunction with any of the computer circuitry, systems, devices, elements, or components shown in the above Figures, among others, as desired. For example, in some embodiments, it may be the case that aspects of the method are implemented by a wireless device, whereas in other embodiments, it may be the case that aspects of the method are implemented by a cellular base station. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, a wireless device and a cellular base station may establish a wireless link. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection between the wireless device and the serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time. In some instances, the cellular connection between the wireless device and the cellular network may include links with multiple cells that operate in different frequency ranges. For example, the wireless device may be attached to at least one cell that operates in 3GPP FR1 as well as at least one cell that operates in 3GPP FR2, as one possibility.

At least in some instances, establishing the wireless link(s) may include the wireless device providing capability information for the wireless device. Such capability information may include information relating to any of a variety of types of wireless device capabilities. Capability information may also or alternatively be provided from the wireless device to the cellular base station (or vice versa) at any of various other times and/or in any of various ways. At least as one possibility, the capability information could include an indication from the wireless device to the cellular base station of artificial intelligence model capability information for the wireless device, for example to indicate what artificial intelligence model parameters (such as maximum number of hidden layers and maximum number of nodes per layer for a neural network type artificial intelligence model) are supported by the wireless device.

In 504, an artificial intelligence model to use for beam selection for the wireless device may be determined. The artificial intelligence model may be trained and/or selected on either of the wireless device side or the cellular network side. Additionally, the artificial intelligence model may be deployed (e.g., used to perform artificial intelligence model inference to perform beam selection) on either of the wireless device side or the cellular network side. Thus, scenarios may be possible in which artificial intelligence model training and inference is performed on the cellular network side, in which artificial intelligence model training and inference is performed on the wireless device side, in which artificial intelligence model training is performed on the wireless device side while artificial intelligence model inference is performed on the cellular network side, or in which artificial intelligence model training is performed on the cellular network side while artificial intelligence model inference is performed on the wireless device side.

For example, in some instances, the cellular network may train one or more artificial intelligence models for use for performing beam selection using performance data collected from performing cellular communication with wireless devices in the cellular network. The artificial intelligence model could be trained for use for a specific cellular base station, or may be trained for use for multiple cellular base stations (for base stations associated with a certain infrastructure type and/or vendor, for base stations in a certain geographical (e.g., tracking) area, and/or according to any of various other possible groupings of base stations), according to various embodiments. In some instances, it may be possible that selection of the artificial intelligence model is based at least in part on wireless device capability information. For example, in a scenario in which artificial intelligence model training and selection is performed by the cellular base station and artificial intelligence model inference is performed by the wireless device, the cellular base station may take into account the capabilities of the wireless device when selecting the artificial intelligence model to be used, e.g., to ensure that the wireless device is capable of using the selected artificial intelligence model to perform beam selection.

In scenarios in which artificial intelligence model training is performed on the wireless device side, the wireless device, or a wireless device vendor or other entity associated with the wireless device, may train one or more artificial intelligence models for use for performing beam selection. For example, a wireless device vendor could use performance data collected (with user consent) from wireless devices associated with the wireless device vendor that perform cellular communication with the cellular base station and/or in the cellular network associated with the cellular base station, to train one or more artificial intelligence models for performing beam selection, and could provide artificial intelligence model information to the wireless device. The wireless device could subsequently use the artificial intelligence model for performing beam selection, or provide the artificial intelligence model to the cellular base station to facilitate the cellular base station performing beam selection using the artificial intelligence model, according to various embodiments.

It may be the case that the artificial intelligence model is trained to use channel impulse response information (and/or other channel state information) for one or more cells in a first frequency range to infer the best beam for a cell (or possibly multiple cells) in a second frequency range. For example, the artificial intelligence model may be usable to take CIR information for one or more cells in 3GPP FR1 and use the information to identify one or more preferred beams for one or more cells in 3GPP FR2. Note that it may be the case that the cell in the first frequency range (e.g., from which the CIR information is obtained and used to infer the preferred beam(s) for the cell in the second frequency range) can be co-located or can be not co-located with the cell in the second frequency range, at least according to some embodiments. In other words, at least in some embodiments, the input to the artificial intelligence model may function as an identifier of the location and orientation of the wireless device to a sufficient degree, e.g., based on the training information provided to the artificial intelligence model, as to allow effective inference of an effective downlink beam to use for cellular communication between the cellular base station and the wireless device via the cell in the second frequency range. Accordingly, embodiments are also envisioned in which the artificial intelligence model could be trained on (and use as an input) one or more other types of information that can be correlated to a downlink beam to use for cellular communication between the cellular base station and the wireless device via the cell in the second frequency range, e.g., in addition or alternative to the CIR information for the cell(s) in the first frequency range.

In 506, CIR information for a cell in a first frequency range (e.g., 3GPP FR1) may be determined. In some instances, it may be possible that CIR information for multiple cells in the first frequency range is determined. The CIR information may be measured by either the wireless device or the cellular base station.

For example, in some embodiments, the cellular base station may configure the wireless device to perform CIR measurement for the cell(s) in the first frequency range, potentially including configuring channel state information reference signals (CSI-RS) for CIR measurement for the cell(s) in the first frequency range. In such a scenario, the cellular base station (and/or another cellular base station serving the wireless device) may transmit the CSI-RS for CIR measurement and the wireless device may receive the CSI-RS for CIR measurement for the cell(s) in the first frequency range, from which the wireless device may determine the CIR information for the cell(s) in the first frequency range.

Depending on where the inference is performed, the CIR measurement by the wireless device in such a scenario may be used directly by the wireless device for artificial intelligence based beam selection and/or may be reported to the cellular base station, e.g., for use by the cellular base station to perform artificial intelligence based beam selection. In case the CIR information is reported, it may be the case that a quantized CIR information report is provided from the wireless device to the cellular base station. In such a scenario, the cellular base station may provide configuration information to the wireless device, e.g., to configure parameters for the quantized CIR report. The quantization can be in the time domain, e.g., where the wireless device reports the amplitude and angle for a certain number of time domain samples, which may be predefined or configured by the cellular base station. As another option, the quantization could be in the frequency domain, e.g., where the sampling rate and duration may be predefined or configured by the cellular base station.

As another example, in some embodiments, the cellular base station may configure the wireless device to transmit sounding reference signals (SRS) for CIR measurement for the cell(s) in the first frequency range. In such a scenario, the wireless device may receive configuration information for the SRS from the cellular base station, and transmit the SRS for CIR measurement for the configured cell(s) in the first frequency range. The cellular base station may receive the SRS from the wireless device and determine the CIR information for the wireless device based at least in part on the SRS transmission(s).

In 508, beam selection for a cell in a second frequency range (e.g., 3GPP FR2) may be performed using the artificial intelligence model and the CIR information for the cell(s) in the first frequency range. As with other aspects of the method of FIG. 5, it may be possible that the beam selection can be performed by the wireless device or by the cellular base station, in various scenarios.

In some scenarios, the wireless device may determine a preferred downlink/transmit beam (or multiple beam options) for the cell in the second frequency range using the artificial intelligence model and the CIR information for the cell(s) in the first frequency range. In such scenarios, the wireless device may provide an indication of the preferred transmit beam(s) for the cell in the second frequency range to the cellular base station. Such reporting may be performed in any of a variety of ways. In some instances, the wireless device may report synchronization signal block resource index (SSBRI) or channel state information reference signal resource index (CRI) information associated with the preferred transmit beam(s) for the cell in the second frequency range. The SSBRI/CRI may be selected/reported based on a list of SSB/CSI-RS resources configured by the cellular base station, or based on the actually transmitted reference signal resources (e.g., SSB resources) in the corresponding component carrier for the cell in the second frequency range. In some instances, it may be possible that multiple beam patterns for SSB/CSI-RS are possible; for example, the cellular base station may configure the beam pattern for SSB/CSI-RS by higher layer signaling (e.g., RRC/MAC), or several beam patterns can be predefined or configured by higher layer signaling and the cellular base station may be able to signal the beam pattern by indicating a beam pattern index (e.g., at any of various possible signaling layers). The wireless device may be able to report one or more than one SSSBRI/CRI, according to various embodiments. As another possibility, the wireless device may report the preferred beam as a preferred downlink transmission direction, e.g., in terms of Azimuth angle of departure (AoD) and Zenith angle of departure (ZoD). The wireless device may be able to report one or more than one AoD/ZoD, according to various embodiments. As a still further possibility, certain beam codebooks could be predefined or configured, and the cellular base station may be able to select and indicate a beam codebook in use for the cell in the second frequency range by higher layer signaling. In such a scenario, the wireless device may be able to report the preferred beam(s) by indicating the corresponding beam index based on the selected beam codebook. The wireless device may be able to report one or more than one beam index, according to various embodiments.

The cellular base station may provide an indication of a transmit/downlink beam for the cell in the second frequency range to the wireless device, which may be selected by the cellular base station based at least in part on the beam selected by the wireless device. In some instances, such an indication may be implicit (e.g., the cellular base station and the wireless device may automatically start to communicate using the new beam if no other beam indication is provided). In some instances, the cellular base station may send an acknowledgement for the beam report to the wireless device. As another option, the cellular base station may explicitly provide a beam indication (e.g., transmission configuration indicator (TCI)) to the wireless device, which may confirm to the wireless device to use the transmit/downlink beam selected by the wireless device, or in some instances could indicate to the wireless device to use a different transmit/downlink beam than the beam selected by the wireless device.

In some scenarios, the cellular base station may directly determine the downlink/transmit beam for the cell in the second frequency range using the artificial intelligence model and the CIR information for the cell(s) in the first frequency range. In such a scenario, after performing inference to identify the downlink/transmit beam for the wireless device for the cell in the second frequency range, the cellular base station may directly provide a TCI with source reference signal based on the selected beam. The cellular base station may trigger more aperiodic CSI-RS for the wireless device for the selected beam, for example for receive beam tracking, time offset tracking, frequency offset tracking, etc.

Once the transmit beam for the wireless device for the cell in the second frequency range has been selected and configured, the cellular base station and the wireless device may perform cellular communication via the cell in the second frequency range using the configured transmit beam. This may include the cellular base station transmitting control information and/or data to the wireless device using the selected beam, and the wireless device receiving the control information and/or data using the selected beam, at least according to some embodiments.

Thus, at least according to some embodiments, the method of FIG. 5 may be used to provide a framework according to which beam selection for a wireless device can be performed with the assistance of artificial intelligence based techniques, and thus to potentially reduce wireless device power consumption and/or increase network resource use efficiency, at least in some instances.

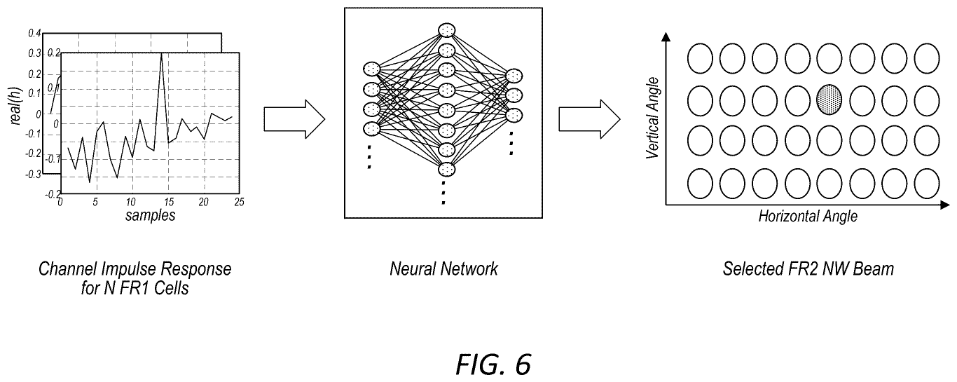

### FIGS. 6-11 and Additional Information

FIGS. 6-11 illustrate further aspects that might be used in conjunction with the method of FIG. 5 if desired. It should be noted, however, that the exemplary details illustrated in and described with respect to FIGS. 6-11 are not intended to be limiting to the disclosure as a whole: numerous variations and alternatives to the details provided herein below are possible and should be considered within the scope of the disclosure.

Beamforming is widely used in wireless communication systems, typically as a technique to improve the link budget. The beamforming may be implemented in both a cellular base station (e.g., gNB, eNB, etc.) and a wireless device (e.g., a UE), for example in a cellular communication system. A good beam pair can help increase the system performance, at least in some instances.

For a gNB-UE beam pair, it may be the case that the gNB transmits multiple downlink reference signals, where different gNB beams may be applied to different reference signals, for the UE to measure the quality for each beam. The UE can further use different receive beams to receive different instances of one reference signal, e.g., to identify the best UE beam for each gNB beam. The downlink reference signals provided by the gNB could include synchronization signal blocks (SSBs), or channel state information reference signals (CSI-RS), in some embodiments. Thus, to identify the gNB-UE beam pair, it may be the case that a UE needs to perform measurement for several gNB beams with UE beam sweeping operation.

However, it may be possible to use machine learning techniques to avoid the need for a UE to perform such extensive beam measurements. Such machine learning techniques may, for example, be used to help to identify the best gNB beam without directly measuring gNB beams, so that the UE can identify a UE beam to accommodate this best gNB beam, potentially more quickly and/or with less overhead than otherwise might be possible.

Aspects of such machine learning techniques could be implemented on the gNB side, in one possible scheme. Alternatively, the machine learning could be implemented on the UE side, in another possible scheme. As further possibilities, the machine learning could be implemented partially by each of the gNB and UE sides. For example, in one scheme, training could be implemented on the gNB side while inference is implemented on the UE side, while in another scheme, training could be implemented on the UE side while inference is implemented on the gNB side. It may be possible that which of such schemes is used can be configured by the gNB, potentially based at least in part on the capability of the UE to support one or more such schemes, e.g., as may be indicated by the UE in capability information provided by the UE to the gNB.

The machine learning techniques may operate to identify the best beam for a cell in a given frequency range (e.g., 3GPP FR2) by using channel impulse response (CIR) information for one or more cells in a different frequency range (e.g., 3GPP FR1). It may be possible that the CIR information is for cells that are or are not co-located with the cell for which beam selection assistance is being provided. It may be the case that the UE can operate in carrier aggregation and/or dual connectivity mode (e.g., to potentially have links with cells in multiple frequency ranges). For dual connectivity mode, it may be the case that the two nodes can have some coordination on the information related to the beam selection and/or CIR.

FIG. 6 illustrates exemplary aspects of one possible approach to performing such machine learning assisted beam selection. In the illustrated example, the CIR for a UE may be measured for one or more FR1 cells, the CIR information may be processed using a neural network, and a best FR2 network beam may thereby be inferred.

The measurement characteristics (e.g., the MIMO channel) used for the CIR measurement may potentially impact the performance of the inference using the machine learning tools, at least according to some embodiments. For example, in some scenarios, it may be the case that more gNB antennas for the MIMO channel can help to improve performance (e.g., beam selection accuracy). In contrast, in some scenarios, it may be the case that more UE antennas for the gNB may not be useful to improve performance, and in some instances could lead to performance loss. Accordingly, as one possibility, the CIR for inference may be a normalized CIR which is for a Nₜₓ*1 channel, where Nₜₓ (e.g., Nₜₓ≥1) indicates the number of antenna ports on the gNB side. When multiple antenna ports are available on the UE side, the channel for one UE antenna port may be selected for performing the CIR measurement, for example the antenna port with the best reference signal receiving power (RSRP).

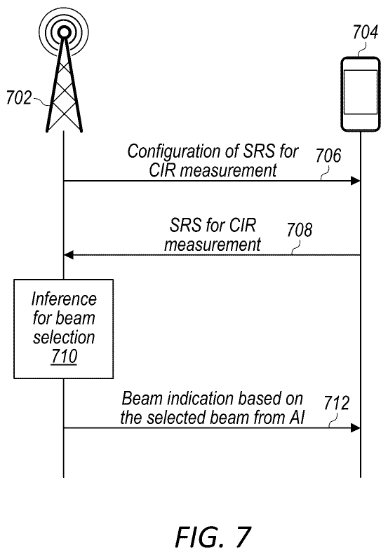

As previously noted herein, one possible scheme for using machine learning for beam selection may include performing the machine learning training and inference on the gNB side. FIG. 7 is a signal flow diagram illustrating exemplary aspects of such a scheme, in which the CIR is measured by a gNB 702 based on sounding reference signal (SRS) transmission by a UE 704, according to some embodiments. As shown, in the illustrated scheme, in 706, the gNB may configure the UE to perform SRS for CIR measurement. To facilitate such configuration, in some embodiments, it may be possible that a new candidate value for the RRC parameter usage for a SRS resource set can be introduced (e.g., “AI-beam-selection”, as one possible candidate value). In 708, the SRS for CIR measurement may be transmitted by the UE 704. The SRS may be transmitted from one antenna port, in some embodiments. It may be the case that the minimal bandwidth for the SRS is predefined, e.g., as a minimal number of resource elements (REs), or a minimal number or resource blocks (RBs), or a minimal number of SRS RB units (e.g., where one SRS RB unit can be predefined and hard-encoded to be a certain number (e.g., “N”) of physical RBs). One SRS resource or resource set may be configured by the network to measure the CIR for one cells, or potentially more than one SRS resources or resource sets may be configured by the network to measure the CIR for multiple cells. The timing advance may also be configured per SRS resource or resource set, e.g., in case of different propagation delays for different cells, according to some embodiments. In 710, the gNB 702 may perform inference for beam selection using the CIR for the UE as measured from the SRS for CIR measurement provided by the UE 704. The inference may be performed using an artificial intelligence (AI) model trained on the network side (e.g., by the gNB and/or other elements of the cellular network of which the gNB forms a part, as various possibilities). In 712, the gNB 702 may provide a beam indication to the UE 704 based on the beam selected using the AI model. This could include the gNB 702 directly providing a transmission configuration indicator (TCI) with source reference signal based on the selected gNB beam, as one possibility. For the UE 704 to identify the UE beam corresponding to the gNB beam, the gNB 702 may trigger aperiodic CSI-RS for L1-RSRP measurement with the selected gNB beam for fast UE beam tracking, in some embodiments. For the UE 704 to identify the time/frequency offset for the gNB beam, the gNB 702 may trigger aperiodic CSI-RS for tracking with the selected gNB beam for fast time/frequency offset tracking, according to some embodiments.

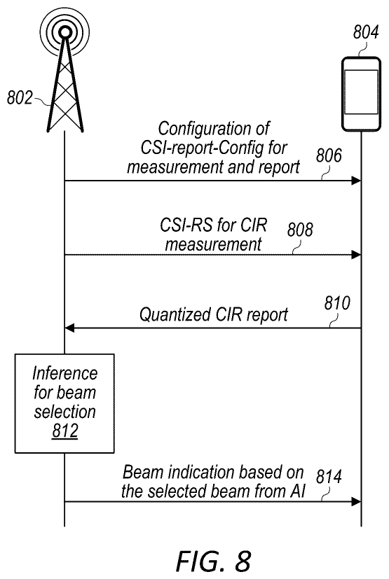

It may also be possible for the CIR to be measured by a UE and reported to a gNB in a scheme in which machine learning training and inference is performed on the gNB side. FIG. 8 is a signal flow diagram illustrating exemplary aspects of such a scheme, according to some embodiments. As shown, in the illustrated scheme, in 806, a gNB 802 may configure a UE 804 to perform channel state information reporting for CIR measurement. To facilitate such configuration, in some embodiments, it may be possible that a new candidate value for the RRC parameter reportQuantity in CSI-reportConfig can be introduced (e.g., “cir”, as one possible candidate value) for a CIR report. In 808, CSI-RS for CIR measurement may be transmitted to the UE 804 by the gNB 802. It may be the case that the minimal bandwidth for the CSI-RS is predefined, e.g., as a minimal number of REs, or a minimal number or RBs. One or more than one CSI-RS resource or resource set may be configured by the network to measure the CIR for one or more cells, according to some embodiments. In 810, the UE 804 may provide a CIR report, which may potentially be quantized, to the gNB 802. The UE 804 may report the CIR measured from one antenna port, in some embodiments. Alternatively, the number of antenna ports for CIR measurements may be explicitly configured, e.g., as part of the CIR report configuration. Note that the number of samples for the quantized CIR report can be configured by the gNB. The quantized reporting could include the UE 804 reporting the amplitude and angle for each time domain sample, or as another option, the CIR may be quantized in the frequency domain, e.g., where the quantized CIR=FFT (CIR), and where the sampling rate and duration can be predefined or configured by the gNB 802. In 812, the gNB 802 may perform inference for beam selection using the CIR for the UE as measured from the CSI-RS for CIR measurement provided to the UE 804 and reported by the gNB 802. As in the scenario of FIG. 7, the inference may be performed using an AI model trained on the network side. In 812, the gNB 802 may provide a beam indication to the UE 804 based on the beam selected using the AI model. This could include the gNB 802 directly providing a TCI with source reference signal based on the selected gNB beam, as one possibility. For the UE 804 to identify the UE beam corresponding to the gNB beam, the gNB 802 may trigger aperiodic CSI-RS for L1-RSRP measurement with the selected gNB beam for fast UE beam tracking, in some embodiments. For the UE 804 to identify the time/frequency offset for the gNB beam, the gNB 802 may trigger aperiodic CSI-RS for tracking with the selected gNB beam for fast time/frequency offset tracking, according to some embodiments.

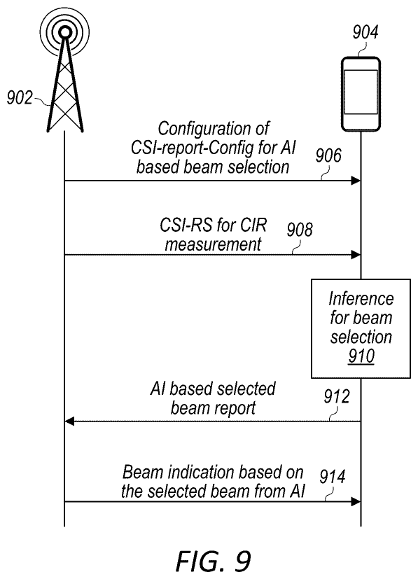

Another possible scheme for using machine learning for beam selection may include performing the machine learning training and inference on the UE side. FIG. 9 is a signal flow diagram illustrating exemplary aspects of one such possible scheme, according to some embodiments. In the illustrated scenario, as shown, a gNB 902 may configure a UE 904 for channel state information reporting for CIR measurement. CSI-RS resources for CIR measurement can be provided to the UE 904 using RRC signaling, e.g., in a CSI-reportConfig information element (IE). In 908, CSI-RS for CIR measurement may be transmitted to the UE 904 by the gNB 902. It may be the case that the minimal bandwidth for the CSI-RS is predefined, e.g., as a minimal number of REs, or a minimal number or RBs. One or more than one CSI-RS resource or resource set may be configured by the network to measure the CIR for one or more cells, according to some embodiments. In 910, the UE 904 may perform inference for beam selection using the CIR for the UE as measured from the CSI-RS for CIR measurement. The inference may be performed using an AI model trained on the UE side (e.g., by the UE, and/or by a vendor of the UE using aggregated crowdsourced data collected from UEs associated with the vendor with user consent, as various possibilities). In 912, the UE 904 may provide an AI based selected beam report to the gNB 902, e.g., to indicate the beam selected by the UE 904 using machine learning assistance. To facilitate such reporting, in some embodiments, it may be possible that one or more new candidate values (e.g., “ssbri” or “cri”, as possible candidate values) can be introduced for RRC beam index reporting for the parameter reportQuantity in CSI-reportConfig. As one option, the UE 904 may report the SSB resource index (SSBRI) or CSI-RS resource index (CRI) in such a manner based on a list of configured SSB/CSI-RS resources in the CSI-reportConfig IE. As another option, the UE 904 may report the SSBRI based on the actually transmitted SSBs in the corresponding component carrier. In some embodiments, it may be possible for the gNB 902 to configure the UE 904 to report one or multiple SSBRI/CRI as well as the possibility for the SSBRI/CRI as the best beam. Note that to account for the possibility that different gNBs could use different beam patterns, it may be possible for the gNB 902 to configure the beam patterns for SSB/CSI-RS by higher layer signaling, or several beam patterns can be predefined and the gNB 902 can indicate a beam pattern index associated with the beam pattern used by the gNB 902.

In some embodiments, it may alternatively be possible for the UE 904 to directly report the preferred beam without configuration of a SSB/CSI-RS list by the gNB 902. For example, the UE 904 may report the preferred downlink transmission angle, e.g., including an Azimuth angle of Departure (AoD) and Zenith angle of Departure (ZoD). The gNB 902 may configure the UE 904 to report one or more than one ZoD/AoD. In some instances, the gNB 902 may configure the UE 904 to report the best beam possibility for the reported beam. In another option, N beam codebooks can be predefined, where each beam codebook contains M beams. The gNB 902 may be able to select one beam codebook by higher layer signaling, and the UE 904 can report the beam index based on the selected beam codebook. The gNB 902 may configure the UE to report one or more than one beam index, in such a scenario. In some instances, the gNB 902 may configure the UE 904 to report the best beam possibility for the reported beam.

After receiving the beam index report, in 914, the gNB may provide a beam indication based on the selected beam from the AI based selected beam report. The indication may be explicit or implicit. For example, as one possibility, both the gNB 902 and the UE 904 may automatically start to communicate with the new beam without explicit beam indication. In such a scenario, the gNB 902 may send an acknowledgement (ACK) for the beam report to the UE, the ACK may be transmitted by a physical downlink control channel (PDCCH) with a dedicated radio network temporary identifier (RNTI) or a PDCCH in a dedicated search space (SS) or control resource set (CORESET). Alternatively, the ACK may be a PDCCH triggering aperiodic CSI-RS for L1-RSRP measurement and/or aperiodic CSI-RS for tracking with the reported beam for fast UE beam refinement and/or time/frequency offset tracking. As a further alternative, the ACK may be based on a timer-based mechanism. For example, within a time window after the beam index report, if the UE 904 does not receive any beam index report triggered by the gNB 902, the UE may be configured to assume the beam index reported by the UE 904 is received by the gNB 902. As another possibility, the gNB 902 may be able to change the beam with the reported beam index based on TCI indication. Thus, the gNB 902 could directly provide a TCI with source reference signal based on the selected gNB beam, at least as one possibility. For the UE 904 to identify the UE beam corresponding to the gNB beam, the gNB 902 may trigger aperiodic CSI-RS for L1-RSRP measurement with the selected gNB beam for fast UE beam tracking, in some embodiments. For the UE 904 to identify the time/frequency offset for the gNB beam, the gNB 902 may trigger aperiodic CSI-RS for tracking with the selected gNB beam for fast time/frequency offset tracking, according to some embodiments.

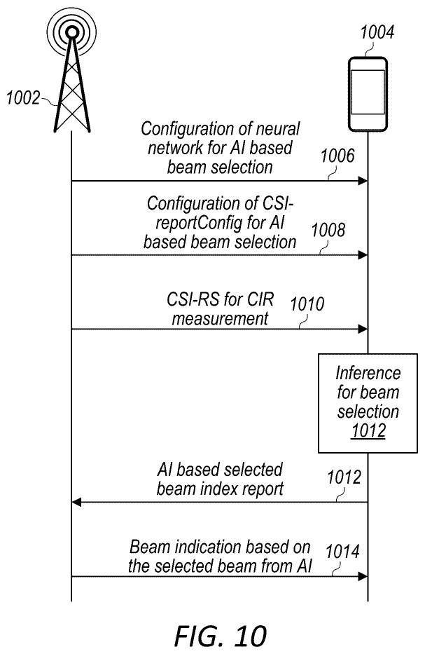

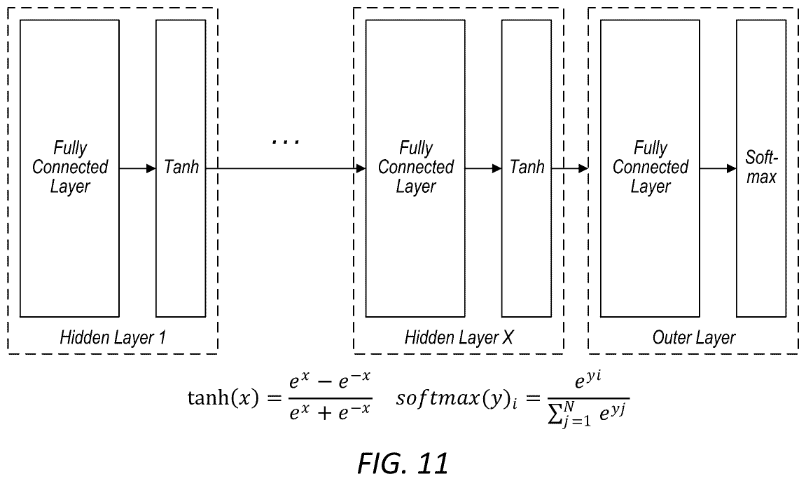

As previously noted herein, schemes in which distributed implementation of aspects of the machine learning assistance to performing beam selection are also possible. FIG. 10 is a signal flow diagram illustrating exemplary aspects of one such possible scheme, in which AI model training is performed on the network side while use of the AI model for inference for beam selection is performed on the UE side, according to some embodiments. As shown, in the illustrated scenario, in 1006, a gNB 1002 may configure a neural network for AI based beam selection for a UE 1004. The gNB 1002 may be able to configure a list of neural networks for beam selection to the UE 1004 by higher layer signaling, e.g., RRC or media access control (MAC) control element (CE). The neural network can contain the weight and activation function for each layer. FIG. 11 illustrates exemplary such characteristics for an example neural network framework. The UE 1004 may report the capability of the UE 1004 with respect to the maximum number of hidden layers and maximum number of nodes per layer to the gNB 1002 (e.g., to facilitate selection of a neural network that is within the capability of the UE 1004 to use), at least according to some embodiments. The neural network to be used for beam selection assistance may be configured per CSI-reportConfig instance, per bandwidth part (BWP), per component carrier (CC), per UE, and/or at any of various other possible levels of granularity.

Once the neural network to be used for the AI based beam selection has been configured at the UE 1004, the beam selection process may operate in a similar manner as illustrated in and described with respect to FIG. 9. This may include, in 1008, the gNB 1002 configuring the UE 1004 with CSI-reportConfig for AI based beam selection. In 1010, the configured CSI-RS for CIR measurement may be provided from the gNB 1002 to the UE 1004. In 1012, the UE 1004 may perform inference for beam selection using the neural network configured by the network and the CIR information determined by the UE 1004 using the CSI-RS for CIR measurement. In 1012, the UE 1004 may provide an AI-based selected beam index report to the gNB 1002. In 1014, the gNB 1002 may provide a beam indication to the UE 1004 based on the beam selected using AI assistance.

In a scheme in which AI model training is performed on the UE side while use of the AI model for inference for beam selection is performed on the network side, it may be possible that the recommended neural network can be reported by MAC CE or RRC signaling. As another option, it may be possible for the UE to report a list of supported neural networks by UE capability. The UE can report the recommended neural network index for beam selection using uplink control information (UCI) or MAC CE or RRC, according to various embodiments. In other respects, such a scheme may operate in a similar manner to a scheme in which both AI model training and inference for beam selection are performed on the network side, such as in the example scenarios illustrated and described herein with respect to FIGS. 7-8, at least according to some embodiments.

In the following further exemplary embodiments are provided.

One set of embodiments may include a method, comprising: by a wireless device: establishing a wireless link with a cellular base station; determining an artificial intelligence model to use for beam selection; determining channel impulse response (CIR) information for a cell in a first frequency range; selecting a preferred transmit beam for a cell in a second frequency range based at least in part on the artificial intelligence model and the channel impulse response information for the cell in the first frequency range; and providing an indication to the cellular base station of the preferred transmit beam for the cell in the second frequency range.

According to some embodiments, the method further comprises: receiving configuration information for the wireless device to perform CIR measurement for the cell in the first frequency range, wherein the configuration information configures channel state information reference signals (CSI-RS) for CIR measurement for the cell in the first frequency range; and receiving the CSI-RS for CIR measurement for the cell in the first frequency range, wherein the CIR information for the cell in the first frequency range is determined based at least in part on the CSI-RS for CIR measurement for the cell in the first frequency range received by the wireless device.

According to some embodiments, the indication of the preferred transmit beam for the cell in the second frequency range includes a synchronization signal block resource index (SSBRI) or channel state information reference signal resource index (CRI) associated with the preferred transmit beam for the cell in the second frequency range.

According to some embodiments, the method further comprises: receiving an indication of a beam pattern for the cellular base station, wherein the preferred transmit beam for the cell in the second frequency range is selected further based at least in part on the beam pattern for the cellular base station.

According to some embodiments, the indication of the preferred transmit beam for the cell in the second frequency range includes an indication of a preferred Azimuth angle of departure and Zenith angle of departure associated with the preferred transmit beam for the cell in the second frequency range.

According to some embodiments, the method further comprises: receiving an indication of a beam codebook for the cellular base station, wherein the indication of the preferred transmit beam for the cell in the second frequency range includes an indication of a beam index selected from the indicated beam codebook for the cellular base station.

According to some embodiments, the method further comprises: receiving an indication of a transmit beam for the cell in the second frequency range in response to the indication to the cellular base station of the preferred transmit beam for the cell in the second frequency range.

According to some embodiments, the method further comprises: providing artificial intelligence model capability information for the wireless device to the cellular base station; and receiving configuration information for the artificial intelligence model to use for beam selection from the cellular base station.

Another set of embodiments may include a wireless device, comprising: one or more processors; and a memory having instructions stored thereon, which when executed by the one or more processors, perform steps of the method of one of the preceding examples.

A further set of embodiments may include a computer program product, comprising computer instructions which, when executed by one or more processors, perform steps of the method of one of the preceding examples.

Yet another set of embodiments may include a method, comprising: by a cellular base station: establishing a wireless link with a wireless device; determining an artificial intelligence model to use for beam selection for the wireless device; determining channel impulse response (CIR) information for the wireless device for a cell in a first frequency range; and performing

beam selection for a cell in a second frequency range based at least in part on the artificial intelligence model and the CIR information for the wireless device for the cell in the first frequency range.

According to some embodiments, the method further comprises: transmitting an indication to the wireless device to perform a sounding reference signal (SRS) transmission for CIR measurement for the cell in the first frequency range; and receiving the SRS transmission for CIR measurement for the cell in the first frequency range from the wireless device, wherein the CIR information for the wireless device for the cell in the first frequency range is determined based at least in part on the SRS transmission for CIR measurement for the cell in the first frequency range.

According to some embodiments, the method further comprises: configuring the wireless device to perform channel state information (CSI) reporting for CIR measurement for the cell in the first frequency range; transmitting CSI reference signals (CSI-RS) for CIR measurement for the cell in the first frequency range to the wireless device; and receiving CSI reporting information for CIR measurement for the cell in the first frequency range from the wireless device, wherein the CIR information for the wireless device for the cell in the first frequency range is determined based at least in part on the CSI reporting information for CIR measurement for the cell in the first frequency range received from the wireless device.

According to some embodiments, CSI reporting information for CIR measurement includes a quantized CIR report, wherein configuring the wireless device to perform the CSI reporting for CIR measurement for the cell in the first frequency range includes configuring parameters for the quantized CIR report.

According to some embodiments, the method further comprises: providing an indication to the wireless device of a transmit beam selected for the cell in the second frequency range, wherein the indication includes a transmission configuration indicator (TCI) with source reference signal based on the selected beam.

According to some embodiments, the method further comprises: triggering one or more of aperiodic channel state information reference signals (CSI-RS) for receive beam tracking or aperiodic CSI-RS for time and frequency offset tracking for a transmit beam selected for the cell in the second frequency range for the wireless device.

According to some embodiments, the method further comprises: receiving an indication of the artificial intelligence model to use for beam selection for the wireless device from the wireless device.

According to some embodiments, the method further comprises: determining CIR information for the wireless device for a second cell in the first frequency range, wherein the beam selection for the cell in the second frequency range is further based at least in part on the CIR information for the wireless device for the second cell in the first frequency range.

A still further set of embodiments may include a cellular base station, comprising: one or more processors; and a memory having instructions stored thereon, which when executed by the one or more processors, perform steps of the method of one of the preceding examples.

A yet further set of embodiments may include a computer program product, comprising computer instructions which, when executed by one or more processors, perform steps of the method of any of one of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for operation in wireless communication, comprising:
determining an artificial intelligence model to use for beam selection;
determining channel impulse response (CIR) information for a cell in a first frequency range;
selecting a preferred transmit beam for a cell in a second frequency range based at least in part on the artificial intelligence model and the channel impulse response information for the cell in the first frequency range; and
providing an indication to the cellular base station of a preferred transmit beam for the cell in the second frequency range.

2. The method of claim 1, wherein the method further comprises:
receiving configuration information for CIR measurement for the cell in the first frequency range, wherein the configuration information configures channel state information reference signals (CSI-RS) for CIR measurement for the cell in the first frequency range; and
receiving the CSI-RS for CIR measurement for the cell in the first frequency range,
wherein the CIR information for the cell in the first frequency range is determined based at least in part on the CSI-RS for CIR measurement for the cell in the first frequency range.

3. The method of claim 1,
wherein the indication of the preferred transmit beam for the cell in the second frequency range includes a synchronization signal block resource index (SSBRI) or channel state information reference signal resource index (CRI) associated with the preferred transmit beam for the cell in the second frequency range.

4. The method of claim 1, wherein the method further comprises:
receiving an indication of a beam pattern for the cellular base station,
wherein the preferred transmit beam for the cell in the second frequency range is selected further based at least in part on the beam pattern for the cellular base station.

5. The method of claim 1,
wherein the indication of the preferred transmit beam for the cell in the second frequency range includes an indication of a preferred Azimuth angle of departure and Zenith angle of departure associated with the preferred transmit beam for the cell in the second frequency range.

6. The method of claim 1, wherein the method further comprises:
receiving an indication of a beam codebook for the cellular base station,
wherein the indication of the preferred transmit beam for the cell in the second frequency range includes an indication of a beam index selected from the indicated beam codebook for the cellular base station.

7. The method of claim 1, wherein the method further comprises:
receiving an indication of a transmit beam for the cell in the second frequency range in response to the indication to the cellular base station of the preferred transmit beam for the cell in the second frequency range.

8. The method of claim 1, wherein the method further comprises:
providing artificial intelligence model capability information to the cellular base station; and
receiving configuration information for the artificial intelligence model to use for beam selection from the cellular base station.

9.-20. (canceled)

21. A processor comprising memory configured to cause the processor to perform operations comprising:
determining an artificial intelligence model to use for beam selection;
determining channel impulse response (CIR) information for a cell in a first frequency range;
selecting a preferred transmit beam for a cell in a second frequency range based at least in part on the artificial intelligence model and the channel impulse response information for the cell in the first frequency range; and
providing an indication to a cellular base station of the preferred transmit beam for the cell in the second frequency range.

22. The processor of claim 21, wherein the memory is further configured to cause the processor to perform operations comprising:
receiving configuration information for CIR measurement for the cell in the first frequency range, wherein the configuration information configures channel state information reference signals (CSI-RS) for CIR measurement for the cell in the first frequency range; and
receiving the CSI-RS for CIR measurement for the cell in the first frequency range,
wherein the CIR information for the cell in the first frequency range is determined based at least in part on the CSI-RS for CIR measurement for the cell in the first frequency range.

23. The processor of claim 21, wherein the indication of the preferred transmit beam for the cell in the second frequency range includes at least one of:
includes a synchronization signal block resource index (SSBRI) or channel state information reference signal resource index (CRI) associated with the preferred transmit beam for the cell in the second frequency range;
an indication of a preferred Azimuth angle of departure and Zenith angle of departure associated with the preferred transmit beam for the cell in the second frequency range; or
an indication of a beam index selected from a beam codebook for the cellular base station.

24. The processor of claim 21, wherein the memory is further configured to cause the processor to perform operations comprising:
receiving an indication of a transmit beam for the cell in the second frequency range in response to the indication to the cellular base station of the preferred transmit beam for the cell in the second frequency range.

25. A cellular base station, comprising:
one or more processors; and
a memory having instructions stored thereon, which when executed by the one or more processors, cause the cellular base station to:
determine an artificial intelligence model to use for beam selection for a wireless device;
determine channel impulse response (CIR) information for the wireless device for a cell in a first frequency range; and
perform beam selection for a cell in a second frequency range based at least in part on the artificial intelligence model and the CIR information for the wireless device for the cell in the first frequency range.

26. The cellular base station of claim 25, wherein the cellular base station is further configured to:
transmit an indication to the wireless device to perform a sounding reference signal (SRS) transmission for CIR measurement for the cell in the first frequency range; and
receive the SRS transmission for CIR measurement for the cell in the first frequency range from the wireless device,
wherein the CIR information for the wireless device for the cell in the first frequency range is determined based at least in part on the SRS transmission for CIR measurement for the cell in the first frequency range.

27. The cellular base station of claim 25, wherein the cellular base station is further configured to:
configure the wireless device to perform channel state information (CSI) reporting for CIR measurement for the cell in the first frequency range;
transmit CSI reference signals (CSI-RS) for CIR measurement for the cell in the first frequency range to the wireless device; and
receive CSI reporting information for CIR measurement for the cell in the first frequency range from the wireless device,
wherein the CIR information for the wireless device for the cell in the first frequency range is determined based at least in part on the CSI reporting information for CIR measurement for the cell in the first frequency range received from the wireless device.

28. The cellular base station of claim 27,
wherein CSI reporting information for CIR measurement includes a quantized CIR report, wherein configuring the wireless device to perform the CSI reporting for CIR measurement for the cell in the first frequency range includes configuring parameters for the quantized CIR report.

29. The cellular base station of claim 25, wherein the cellular base station is further configured to:
trigger one or more of aperiodic channel state information reference signals (CSI-RS) for receive beam tracking or aperiodic CSI-RS for time and frequency offset tracking for a transmit beam selected for the cell in the second frequency range for the wireless device.

30. The cellular base station of claim 25, wherein the cellular base station is further configured to:
receive an indication of the artificial intelligence model to use for beam selection for the wireless device from the wireless device.

31. The cellular base station of claim 25, wherein the cellular base station is further configured to:
determine CIR information for the wireless device for a second cell in the first frequency range,
wherein the beam selection for the cell in the second frequency range is further based at least in part on the CIR information for the wireless device for the second cell in the first frequency range.
